(19) United States
(12) Patent Application Publication
(10) Pub. No.: US 2013/0325578 A1
(43) Pub. Date: Dec. 5, 2013

(54) METHOD FOR ENABLING A CUSTOMER TO PERFORM A TRANSACTION FOR AN ITEM USING VARIOUS LOYALTY PROGRAMS

(71) Applicants: Douglas A. Ajram, Westmount (CA); Carlo Colella, Beaconsfield (CA)

(72) Inventors: Douglas A. Ajram, Westmount (CA); Carlo Colella, Beaconsfield (CA)

(21) Appl. No.: 13/597,955

(22) Filed: Aug. 29, 2012

Related U.S. Application Data
(60) Provisional application No. 61/655,306, filed on Jun. 4, 2012.

(51) Int. Cl. G06Q 30/02

(52) U.S. Cl. 705/14.28

(57) ABSTRACT

A method and apparatus are disclosed, the method for enabling a customer to perform a transaction for an item. A plurality of loyalty programs may be used to perform the transaction. A cash payment may additionally be used if not enough points are used for the transaction. A profit made from the transaction is determined and is shared amongst the clients managing the loyalty programs used for performing the transaction.

### CROSS-REFERENCE TO RELATED APPLICATIONS

The application claims priority of U.S. Patent Application No. 61/655,306 entitled “Method for Enabling a Customer to Perform a Transaction for an Item Using Various Loyalty Programs”, filed on Jun. 4, 2012, the specification of which is hereby incorporated by reference.

### FIELD OF THE INVENTION

The invention relates to electronic commerce. More precisely, this invention pertains to a method for enabling a customer to perform a transaction for an item using various loyalty programs.

### BACKGROUND

Electronic commerce is now widely spread. In fact, it is now quite easy to purchase items on the Internet using a browser.

Loyalty programs have been introduced many decades ago and are of great interest for customers. They basically enable customers to save points when purchases are made and subsequently use the points saved to obtain other items.

One drawback of some of the loyalty programs is that the number of items that can be obtained using the points is sometimes quite limited and depends on a loyalty program.

Another drawback is that a customer may be a member of more than one loyalty program and may save points for each of the more than one loyalty program. As a result, the customer “purchase” power via the loyalty programs may be fragmented amongst the various loyalty programs to which the customer belongs to.

An additional issue also with the loyalty programs is their costs.

There is a need for a method and apparatus that will overcome at least one of the above-identified drawbacks.

Features of the invention will be apparent from review of the disclosure, drawings and description of the invention below.

### BRIEF SUMMARY

According to a broad aspect of the invention, there is provided a method for enabling a customer to perform a transaction for an item, the customer being a member of a plurality of loyalty programs, the method comprising determining a price for an item to buy by the customer, displaying on the interface an invitation to the customer for entering more than one point value, each of the more than one point value being associated with a loyalty program of the plurality of loyalty programs, each loyalty program being managed by a client; upon entering of the more than one point value; determining a total redeemed amount associated with the entered more than one point value and comparing the total redeemed amount to the determined price of the item to buy and completing the transaction if the total redeemed amount is equal to the determined price; if the determined total redeemed amount associated with the entered more than one point value is lower than the determined price of the item to buy, offering the customer to pay a difference using a cash payment and completing the transaction if the cash payment is made; if the transaction is completed, determining a profit made from the transaction and providing a share of the profit determined to the client managing the loyalty point program that the customer used in proportion to points used for payment.

In accordance with an embodiment, the customer is one of an individual, a group of individuals, a corporation, a group of corporations.

In accordance with one embodiment, the determining of a price for an item to buy by the customer comprises displaying an interface to the customer, the user selecting the item to buy on the user interface and determining a price for the selected item to buy.

In accordance with one embodiment, the displaying of an interface to the customer comprises accessing a website and browsing the website.

In accordance with one embodiment, the displaying of an interface to the customer comprises executing an application.

In accordance with one embodiment, the determining of a price for the item to buy comprises accessing a database and obtaining the price from the accessed database.

In accordance with one embodiment, the method further comprises obtaining another price from another third party price source and modifying the determined price if the obtained price from the other third party price source is lower than the determined source.

In accordance with another embodiment, the method further comprises the customer registering before determining a price for an item to buy by the customer.

In accordance with another embodiment, the registering comprises providing an indication of the plurality of loyalty programs, the customer is member of.

In accordance with one embodiment, the registering further comprises providing login access information for each of the loyalty programs of the plurality.

In accordance with a further embodiment, the determining of a total redeemed amount associated with the entered more than one point value comprises accessing a table comprising a redeemed value of a point for each of the entered more than one point value.

In accordance with another embodiment, the completing of the transaction if the total redeemed amount is equal to the determined price comprises for each of the entered more than one point value accessing a corresponding loyalty program site to ensure the customer has a sufficient amount of points available in its corresponding account.

In accordance with another embodiment, the performing of the cash payment comprises using one of using a credit card and an online payment system.

In accordance with another embodiment, the profit determined comprises a net profit.

In accordance with another embodiment, the method further comprises providing a share of the profit made to the customer.

In accordance with another embodiment, the providing of the share of the profit made to the customer comprises at least one of providing the customer with a credit for a future transaction and crediting a credit card of the customer.

According to a broad aspect of the invention, there is provided a computer-readable storage medium storing computer-executable instructions which, when executed, cause a processing device to perform a method for enabling a customer to perform a transaction for an item, the customer being a member of a plurality of loyalty programs, each loyalty program being managed by a client, the method comprising the customer selecting the item to buy on an interface, determining a price for the item to buy, displaying on the interface an invitation to the customer for entering more than one point value, each of the more than one point value being associated with a loyalty program of the plurality of loyalty programs; upon entering of the more than one point value; determining a total redeemed amount associated with the entered more than one point value and comparing the total redeemed amount to the determined price of the item to buy and completing the transaction if the total redeemed amount is equal to the determined price; if the determined total redeemed amount associated with the entered more than one point value is lower than the determined price of the item to buy, offering the customer to pay a difference using a cash payment and completing the transaction if the cash payment is made; if the transaction is completed, determining a profit made from the transaction and providing a share of the profit determined to the client managing the loyalty program that the customer used in proportion to points used for payment.

In accordance with another broad aspect of the invention, there is provided a computing device, the computing device comprising: a display device; a central processing unit; a memory comprising a program, wherein the program is stored in the memory and configured to be executed by the central processing unit, the program comprises: instructions for enabling a customer to select an item to buy on an interface; instructions for determining a price for the item to buy; instructions for displaying on a customer interface an invitation to the customer for entering more than one point value, each of the more than one point value being associated with a loyalty program of a plurality of loyalty programs; instructions for determining a total redeemed amount associated with the entered more than one point value upon entering of the more than one point value; instructions for comparing the total redeemed amount to the determined price of the item to buy; instructions for completing the transaction if the total redeemed amount is equal to the determined price; instructions for offering the customer to pay a difference using a cash payment if the determined total redeemed amount associated with the entered more than one point value is lower than the determined price of the item to buy; instructions for completing the transaction if the cash payment is made; instructions for determining a profit made from the transaction and for providing a share of the profit determined to the client managing the loyalty point program that the customer used in proportion to points used for payment.

In accordance with one embodiment, the computing device further comprises a communication port and the program is received via the communication port.

An advantage of the method disclosed is that it may help to reduce the cost of running a loyalty program. In fact, all the cost relating to operating a loyalty program with another provider is reduced or removed, the turnkey solution disclosed herein will provide a solution at no cost to the client, the benefit derived is via, inter alia, the selling for instance of merchandise, services and travel through the system disclosed herein and having the customer use points as a full payment or as a partial payment

Another advantage of the method disclosed herein is that a customer may obtain an item using points originating from a plurality of loyalty programs.

Another advantage of the method disclosed herein is that a customer may have access to a wide range of items which can be obtained using a plurality of loyalty programs.

### BRIEF DESCRIPTION OF THE DRAWINGS

In order that the invention may be readily understood, embodiments of the invention are illustrated by way of example in the accompanying drawings.

FIG. 1 is a diagram which shows an embodiment of a system in which the method for enabling a customer to perform a transaction for an item may be implemented. In this embodiment, the system comprises an apparatus for enabling a customer to perform a transaction for an item, a customer, a data network and a plurality of clients.

FIG. 2 is a flowchart which shows an embodiment of a method for enabling a customer to perform a transaction for an item. According to a first processing step, an item to buy is selected in an interface. According to a second processing step, a price for the item to buy is determined. According to a third processing step, an interface for entering more than one point value is displayed. According to a fourth processing step, a total redeemed value associated to the determined price is determined. According to another processing step, a customer is offered to pay a difference using a cash payment. According to a further processing step, the transaction is completed. According to a further processing step, a profit made from the transaction is determined and according to a final processing step, a share of the profit made from the transaction is provided.

FIG. 3 is a flowchart which shows an embodiment of a method for determining a price for an item to buy. According to a first processing step, an item to buy is selected on an interface. According to a second processing step, a database is accessed. According to a third processing step, a price is obtained from the database.

FIG. 4 is a flowchart which shows an embodiment of a method for selecting an item to buy on an interface. According to a first processing step, a website is accessed. According to a second processing step, the website is browsed. According to a third processing step, the item to buy is selected.

FIG. 5 is a flowchart which shows an embodiment for determining a total redeemed amount associated to the determined price. According to a first processing step, a given loyalty program used is selected. According to a second processing step, a value for a given amount of points used is determined for the loyalty program selected. According to a further processing step, a total value for all points used for all loyalty programs used is determined. According to a further processing step, a redeemed amount is provided.

FIG. 6 is a flowchart which shows an embodiment for completing the transaction. According to a first processing step, a given loyalty program used is selected. According to a further processing step, a check is performed in order to find out if the payment is possible. According to a further processing step, a check is performed in order to find out if other loyalty programs are used. According to a further processing step, a check is performed in order to find out if cash is used for the transaction. According to a further processing step, a check is performed in order to find out if the payment is possible and according to a further processing step, a confirmation that the transaction can be performed is provided.

FIG. 7 is a flowchart which shows an embodiment for providing a share of the profits made from the transaction. According to a first processing step, a determined amount of profit is provided. According to an optional further processing step, the customer is provided with a share of the determined amount of profit and according to a further processing step, each client is provided with a share of the profits.

FIG. 8 is a block diagram which shows an embodiment of the apparatus enabling a customer to perform a transaction for an item.

FIG. 9 is a table which shows various embodiments illustrating benefits of the method disclosed herein.

Further details of the invention and its advantages will be apparent from the detailed description included below.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details.

Terms

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “whereby” is used herein only to precede a clause or other set of words that expresses only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. Section 1.72(b). The title of the present application and headings of sections provided in the present application are for convenience only, and are not to be taken as limiting the disclosure in any way.

The term customer shall be given broad meaning in accordance with terminology of the art and includes (and be interchangeably referred to as) an individual, a group of individuals, a corporation and a group of corporations that is/are member of at least one loyalty program or that are entitled to benefit from at least one loyalty program.

The term client shall be given broad meaning in accordance with terminology of the art and include providers or managers of loyalty programs in which points are assigned to a respective member. Examples of known loyalty programs or companies having a loyalty program include Aeroplan™, Alaska Airline™, American Airlines™, Jet Blue™, Priority Club™, United Airlines™, US Airlines™, Virgin Airlines™, Accor Hotel™, Aero Lingus™, Air France™, KLM™, Amtrak™, Asia Miles™, BAA World Points™, Choice Hotels™, CVS™, Delta™, Diners™, Finnair™, Hilton HHonors™, Hyatt Gold™, Nectar™, SAS™, RBC™, CIBC™, National Bank™, Citi™, Band of America™, Wells Fargo™, PNC™, TD Bank™, HSBC™, ATT™, Verizon™, AirMiles™, Starwood™, etc.

The term item shall be given broad meaning in accordance with terminology of the art and includes (and be interchangeably referred to as) a good, a service, etc. provided by a manufacturer or a distributor. Examples of goods comprise a piece of art, a piece of jewelry, an electronic device, a kitchen appliance, a gourmet item, a leisure-related object, a sports-related object, a beauty product, a luxury product or item, a toy, a game, an outdoor equipment, a gift cards, etc. Examples of services comprise a spa treatment, a wine event, a car related event, a sea related event, an air related event, a concierge service, an airline ticket, a hotel reservation, a cruise, a lifestyle product, etc.

Various embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

As disclosed below, the invention may be implemented in numerous ways, including as a method, an apparatus, a system, a computer readable medium such as a computer readable storage medium or a computer network wherein program instructions are sent over optical or communication links. In this specification, these implementations, or any other form that the invention may take, may be referred to as systems.

With all this in mind, the present invention is directed to a method, a computer-readable storage medium and apparatus for enabling a customer to perform a transaction for an item using various loyalty programs.

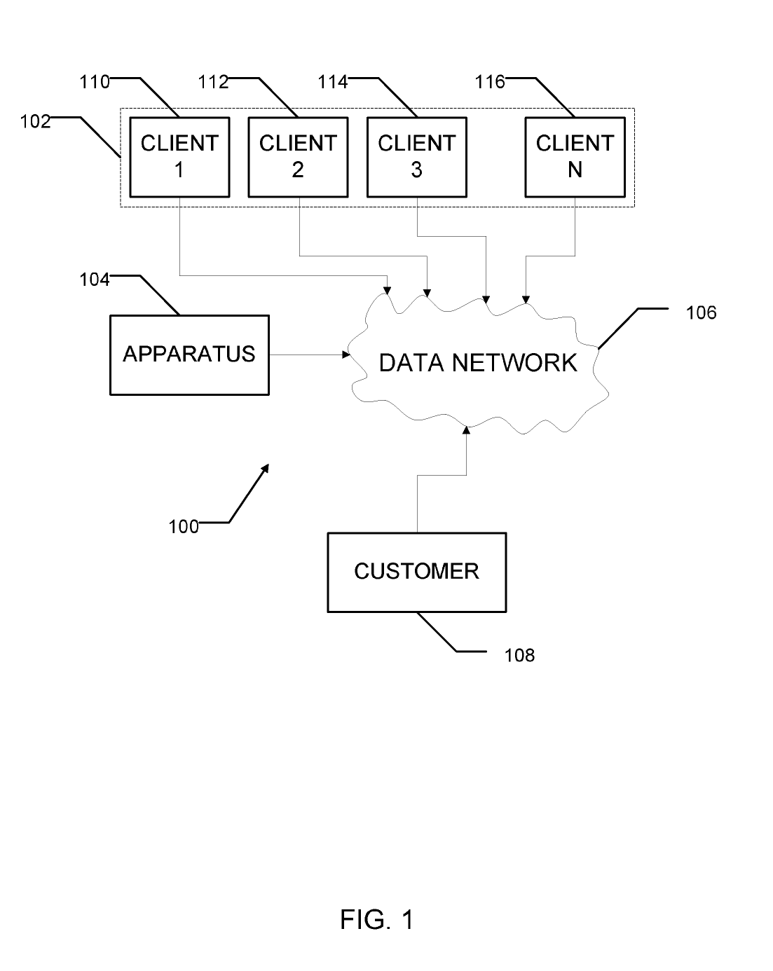

Now referring to FIG. 1, there is shown an embodiment of a system in which the method for enabling a customer to perform a transaction for an item is implemented.

More precisely, the system 100 comprises a plurality of clients 102, an apparatus for enabling a customer to perform a transaction 104, a data network 106 and a customer 108.

In this embodiment, the plurality of clients 102 comprises client 1 110, client 2 112, client 3 114 and client N 116.

The apparatus for enabling a customer to perform a transaction 104 is operatively connected to the customer 108 and to the plurality of clients 102 via the data network 106.

It will be appreciated that the customer 108 is provided with a processing device such as a laptop, a desktop, a smart phone, and a tablet computer or the like. The processing device of the customer 108 is operatively connected to the apparatus for enabling a customer to perform a transaction 104 via the data network 106.

In a preferred embodiment, the customer is any individual wanting to buy items on an online facility, e-store and wanting to pay by credit card and/or use points as a form of full or partial payment. This customer may be located for instance in North America, in South America, in Europe, in Asia, in Australia, in the Middle East or in Africa.

It will be further appreciated that the apparatus for enabling a customer to perform a transaction for an item 104 comprises a processing device selected from a group consisting of servers, desktop computers or the like. In a preferred embodiment, the processing device of the apparatus for enabling a customer to perform a transaction for an item 104 is a server as further detailed below.

Each of the pluralities of clients 102 comprises corresponding processing devices which may be selected from the group consisting of desktop computers, servers, or the like. The skilled addressee will appreciate that a corresponding processing device depends on the client and may be constituted of a network of processing devices.

It will be appreciated that the data network 106 may comprise at least one of a local area network (LAN), a metropolitan area network (MAN) and a wide area network (WAN).

In a preferred embodiment, the data network 106 comprises the Internet.

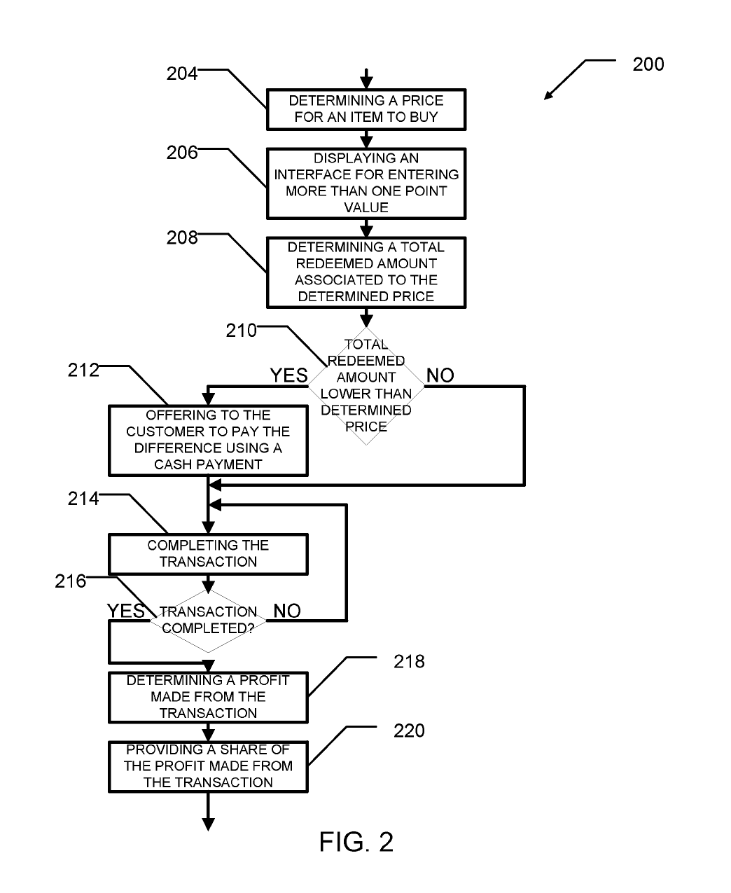

Now referring to FIG. 2, there is shown an embodiment of the method for enabling a customer to perform a transaction for an item. It will be appreciated that the transaction may be performed in real-time.

According to processing step 202, an item to buy is selected on an interface.

The item to buy is selected by the customer 108 using its processing device. In this embodiment, the interface is displayed on the processing device of the customer 108. The interface is generated using data received from the apparatus for enabling a customer to perform a transaction 104. It will be appreciated that the item to buy may be displayed according to various embodiments as explained further below.

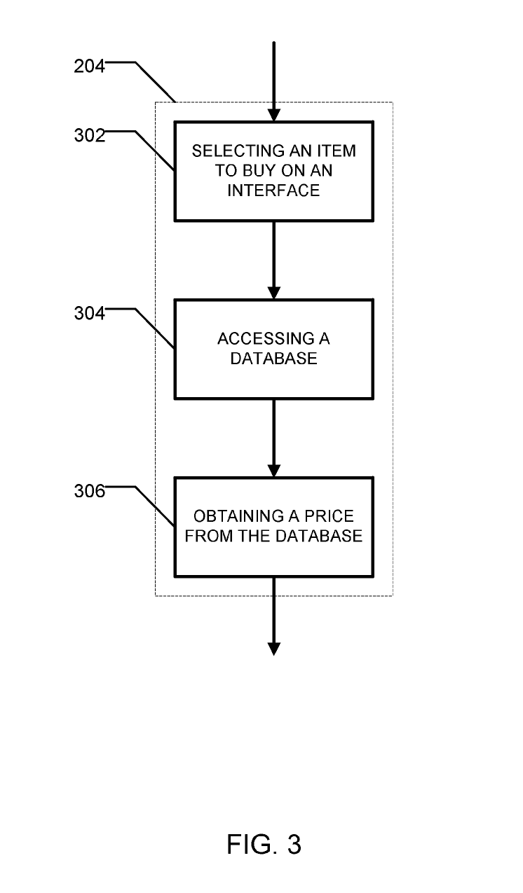

Now referring to FIG. 3, there is shown an embodiment for selecting an item to buy on the interface.

According to processing step 204, a price is determined for an item to buy.

It will be appreciated that the determining of the price for an item to buy by the customer may be performed according to various embodiments.

Now referring to FIG. 3, there is shown an embodiment for determining the price of an item to buy by the customer.

According to processing step 302, an item to buy is selected on an interface.

It will be appreciated that the interface may be of various types. In one embodiment, the displaying of the interface comprises executing an application.

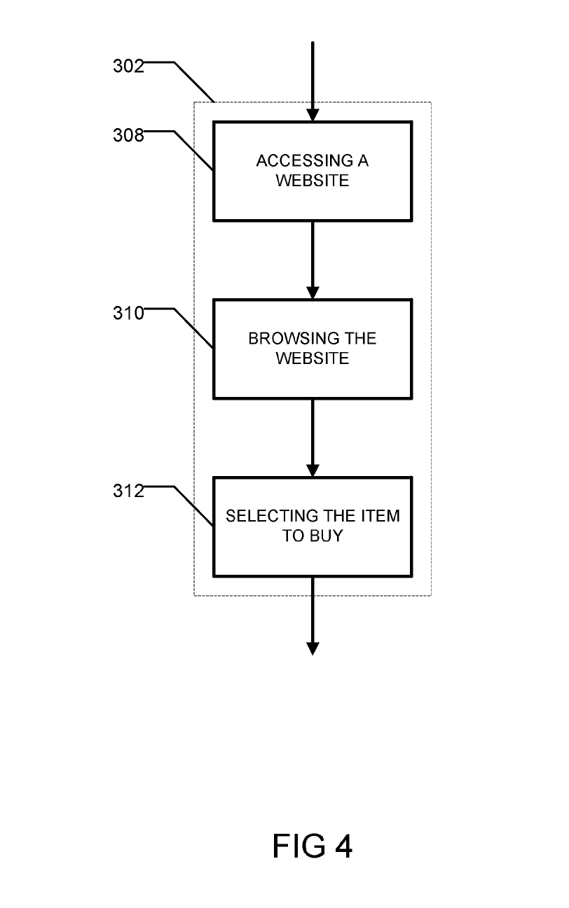

Now referring to FIG. 4, there is shown another embodiment for selecting an item to buy on the interface.

According to processing step 308, a website is accessed.

It will be appreciated that the website is accessed by the processing device of the customer 108 via the data network 106. In one embodiment, the website is provided by the apparatus for enabling a customer to perform a transaction for the item 104.

The skilled addressee will appreciate that the website may be provided according to various embodiments.

In a preferred embodiment, the website is provided using Adobe™ Coldfusion™ and Microsoft™ SQL.

According to processing step 310, the website is browsed by the user.

It will be appreciated that the website may be browsed according to various embodiments known to the skilled addressee. In particular and in one embodiment, a browser may be used for browsing the website.

According to processing step 312, the item to buy is selected on the website browsed by the user.

It will be appreciated that the system will not be using a specific browser, but the client will need to access the site via a browser of his/her choice.

It will be appreciated that the item may be of various types, as mentioned above.

Now referring back to FIG. 3 and according to processing step 304, a database is accessed. It will be appreciated that in one embodiment the database is operatively connected to a webserver generating the website.

According to processing step 306, a price is obtained from the database accessed. In one embodiment, the determination of the price is performed by accessing a database operatively connected to the web server generating the website.

In a preferred embodiment, it will be appreciated that the price for the item may be updated on a regular basis to ensure that the value provided to the customer is up-to-date and accurate.

In one embodiment, the updating of the price for the item may comprise obtaining another price from another third party source and modifying the determined price if the obtained price from the other third party source is lower than the determined source. The third party source may be a website. It will be appreciated that the checking may occur at various points in time such as when browsing the items and when checking out as explained further below.

Also when checking out, the price for the item may be checked out using the price of on other websites in order to make sure that it is at retail price or even better. In such case, the customer can check out with a further reduction or status quo using credit and loyalty as a form of payment.

Now referring back to FIG. 2 and according to processing step 206, an interface is displayed for entering more than one point value.

It will be appreciated that the interface is displayed on the processing device of the customer 108.

Entering more than one point value means that the customer is capable of simultaneously enter a corresponding number of points for each of more than one loyalty programs. Accordingly, instead of using a single loyalty program provided by one client of the plurality of clients, the customer 108 is capable of simultaneously using more than one loyalty program.

It will be appreciated that the interface displayed for entering more than one point value may be configured according to user preferences. In fact, it will be appreciated that in such embodiment the customer has to register prior performing a purchase. The registration would comprise providing an indication of loyalty programs to which the customer is enrolled.

Also and in one embodiment, the registering may further comprise providing login access information for each of the loyalty programs of the plurality, the customer is enrolled.

Still referring to FIG. 2 and according to processing step 208, a total redeemed amount associated to a determined price is determined.

As mentioned above, it will be appreciated that a plurality of loyalty programs may be simultaneously used by the customer 108 to purchase the item. It will be appreciated that the item may be fully paid, or not, using the plurality of loyalty programs.

In the case where a plurality of programs is used, a total redeemed amount has to be determined.

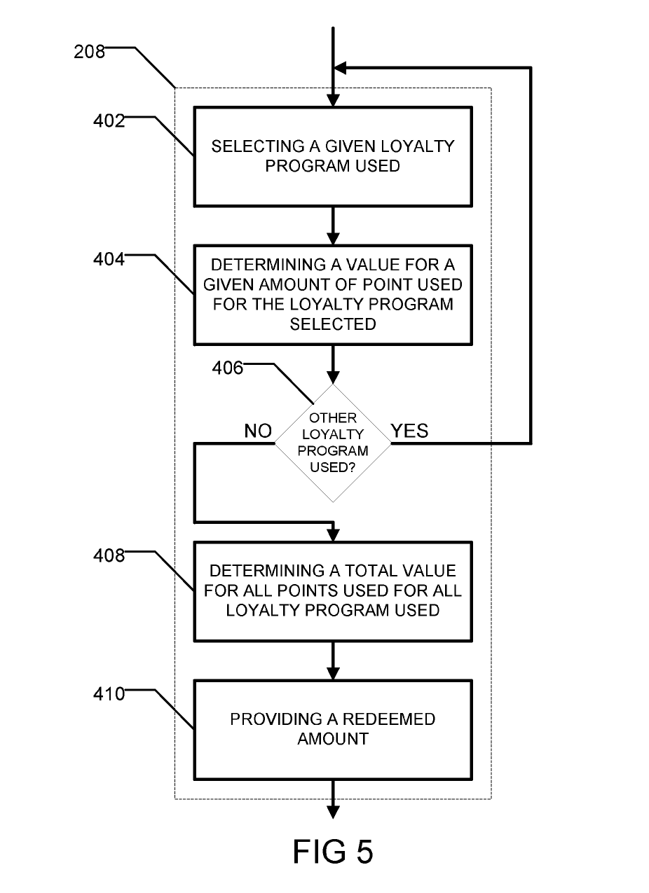

Now referring to FIG. 5, there is shown an embodiment for determining the total redeemed amount associated to the determined price.

According to processing step 402, a given loyalty program used by the customer is selected.

Still referring to FIG. 5 and according to processing step 404, a value corresponding to a given amount of points used for the given loyalty program selected is determined. The skilled addressee will appreciate that a redeemed value associated to a given amount of points differs depending on a loyalty program.

In one embodiment, the determination is performed by the apparatus for enabling a customer to perform a transaction 104. The determination is performed by accessing a database comprising a table with a redeemed value of a point for each loyalty program available.

Still referring to FIG. 5 and according to processing step 406, a test is performed in order to find out if other loyalty programs are used by the customer.

In fact and as mentioned above, it will be appreciated that while in one embodiment the customer may use a single loyalty program, in an alternative embodiment, the user may use a plurality of loyalty programs for performing a single purchase. In the case where no other loyalty programs are used and in accordance with processing step 408, a total redeemed amount for all points used for all loyalty programs used is determined. It will be appreciated that the determination of the total redeemed amount is performed by adding the redeemed values associated with each loyalty program used.

According to processing step 410, a redeemed amount is provided.

Now referring back to FIG. 2 and according to processing step 210, a check is performed in order to find out if the total redeemed amount is lower than a determined price for an item.

In fact, it will be appreciated that in some instances, while the customer uses a plurality of points associated with a plurality of loyalty programs, the total redeemed amount may still be lower than the determined price of the item. In such embodiment and in accordance with processing step 212, the customer is offered to pay the difference between the total redeemed amount and the determined price of the item using a cash payment.

It will be appreciated that the cash payment may be any one of a payment made using a credit card, an online payment system (such as PayPal™), etc. More generally, any form of payment outside of loyalty points may be used for the cash payment.

In accordance with processing step 214, the transaction is completed.

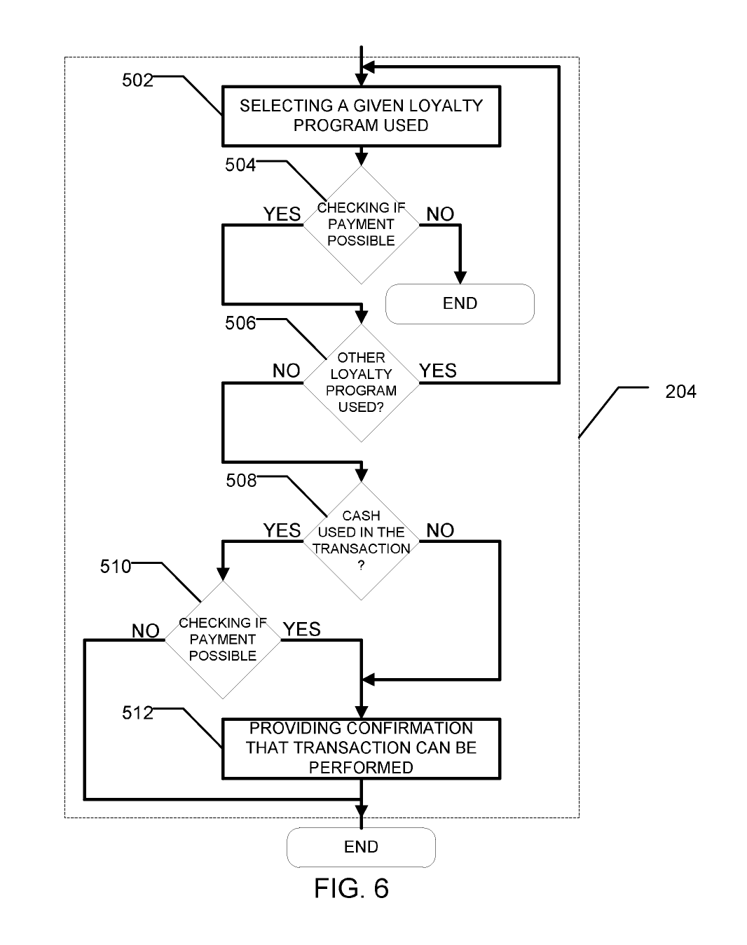

Now referring to FIG. 6, there is shown an embodiment for completing the transaction. The skilled addressee will appreciate that various alternative embodiments may be possible.

According to processing step 502, a given loyalty program used is selected.

According to processing step 504, a check is performed in order to find out if a payment is possible for the given loyalty program selected.

It will be appreciated that the checking to find out if the payment is possible for the given loyalty program selected is performed by accessing the corresponding loyalty program site to ensure that the customer has a sufficient amount of points available in his account for that loyalty program selected.

In the case where the payment is possible for the loyalty program selected and in accordance with processing step 506, a check is performed in order to find out if other loyalty programs are used.

In a case where there is no other loyalty programs used for that specific transaction and in accordance with processing step 508, a check is performed in order to find out if a cash payment is used in this transaction.

In the case where a cash payment is used in the transaction and in accordance with processing step 510, a check is performed in order to find out if the payment is possible for the cash payment.

It will be appreciated that the payment may not be possible for various reasons known to the skilled addressee such as for instance if a credit card used for the cash payment is declared stolen for instance.

In the case where the cash payment is possible and in accordance with processing step 512, a confirmation that the transaction can be performed is provided. It will be appreciated that at this point, the customer may be able to obtain the item.

Now referring back to FIG. 2 and according to processing step 220, a share of the profits made using the transaction is provided.

It will be appreciated that the share of the profits made with the transaction may be provided according to various embodiments. It will be appreciated that profits should be understood as net operating profits in one embodiment.

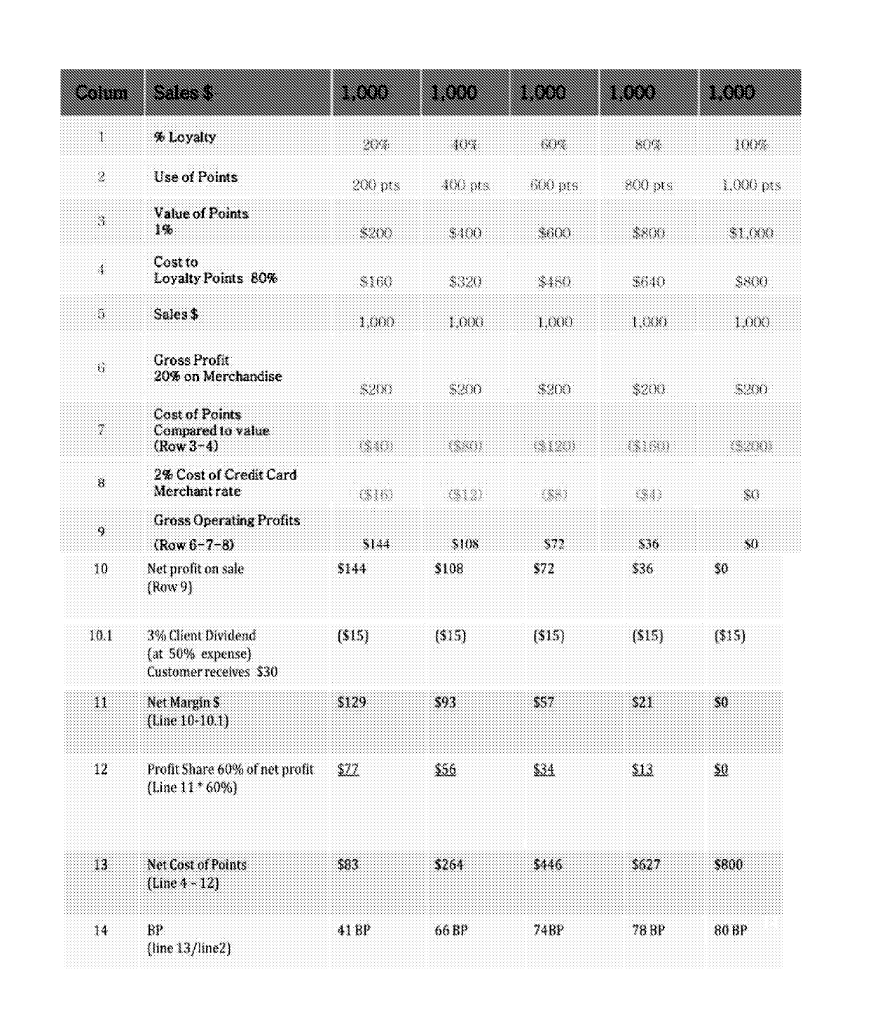

Now referring to FIG. 9, there is shown an example of net operating profits made from the sale of a given item at a price of 1000$ for various cases.

In a first case, a portion of 20% of the price of the item is paid using at least one loyalty program. In such case and based on certain hypothesis such as a value of a point, a cost of payment with a credit card and a gross profit, a net operating profit of 144$ is available.

In a second case, a portion of 40% of the price of the item is paid using at least one loyalty program. Assuming the same hypothesis than in the case where a portion of 20% of the price of the item is paid using the loyalty program, a net operating profit of 108$ is available.

In a third case, a portion of 60% of the price of the item is paid using at least one loyalty program. Assuming the same hypothesis than in the case where a portion of 20% of the price of the item is paid using the loyalty program, a net operating profit of 72$ is available.

In a fourth case, a portion of 80% of the price of the item is paid using at least one loyalty program. Assuming the same hypothesis than in the case where a portion of 20% of the price of the item is paid using the loyalty program, a net operating profit of 36$ is available.

In a fifth case, a portion of 100% of the price of the item is paid using at least one loyalty program. Assuming the same hypothesis than in the case where a portion of 20% of the price of the item is paid using the loyalty program, a net operating profit of 0$ is available.

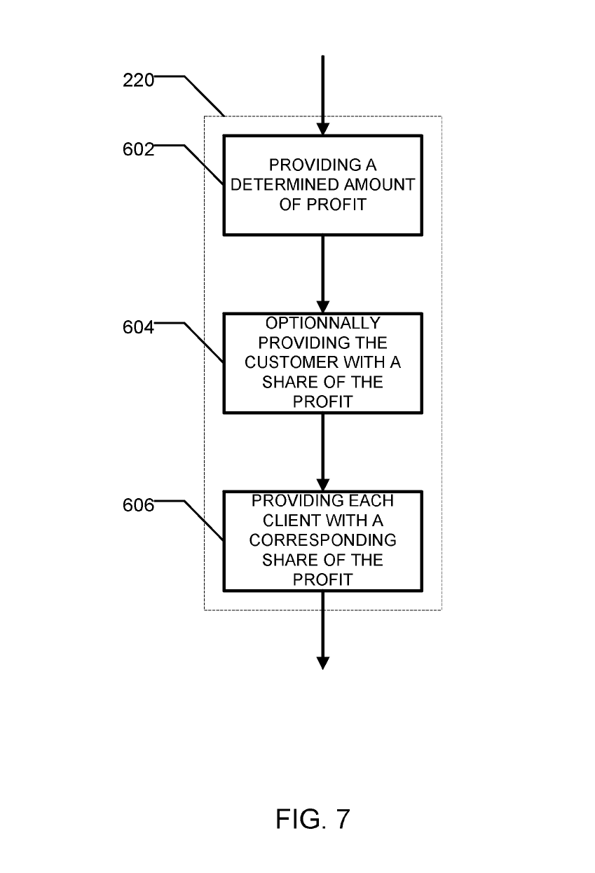

Now referring to FIG. 7, there is shown an embodiment for providing a share of the profits (net operating profits) made with the transaction.

It will be appreciated that the share of the profits may be provided according to various embodiments.

According to processing step 602, a determined amount of profit is provided.

According to processing step 604, the customer is provided back with a share of the profits.

It will be appreciated that the customer may be provided with a share of the profits according to various embodiments. For instance, the customer may be provided with a rebate to be used in a future transaction. This may be implemented by allocating a reward to the customer in the form of points that can be redeemed later for a given amount of future purchases or it may be implemented in the form of points for at least one of the partners that the customer has used as a point redemption. In an alternative embodiment, the credit card of the customer may be credited with a share of the profits.

Moreover, it will be appreciated that this processing step is optional and that in one embodiment the customer does not obtain a share of the profits made in this transaction.

FIG. 9 shows some embodiments of possible profit sharing.

Still referring to FIG. 7 and in accordance with processing step 606, each client involved in the transaction is provided with a corresponding share of the profits.

It will be appreciated that the corresponding share of the profits may be determined according to various embodiments.

For instance and in one embodiment, the corresponding share of the profits for a given client may be determined based on a proportion of a redeemed value associated with the loyalty program provided by the given client over the total redeemed value in the case where more than one loyalty program is used.

The skilled addressee will appreciate that providing a share of the profits back to a client is of great interest. In fact it helps reducing the cost of a loyalty program which is of great advantage for the client managing the loyalty program.

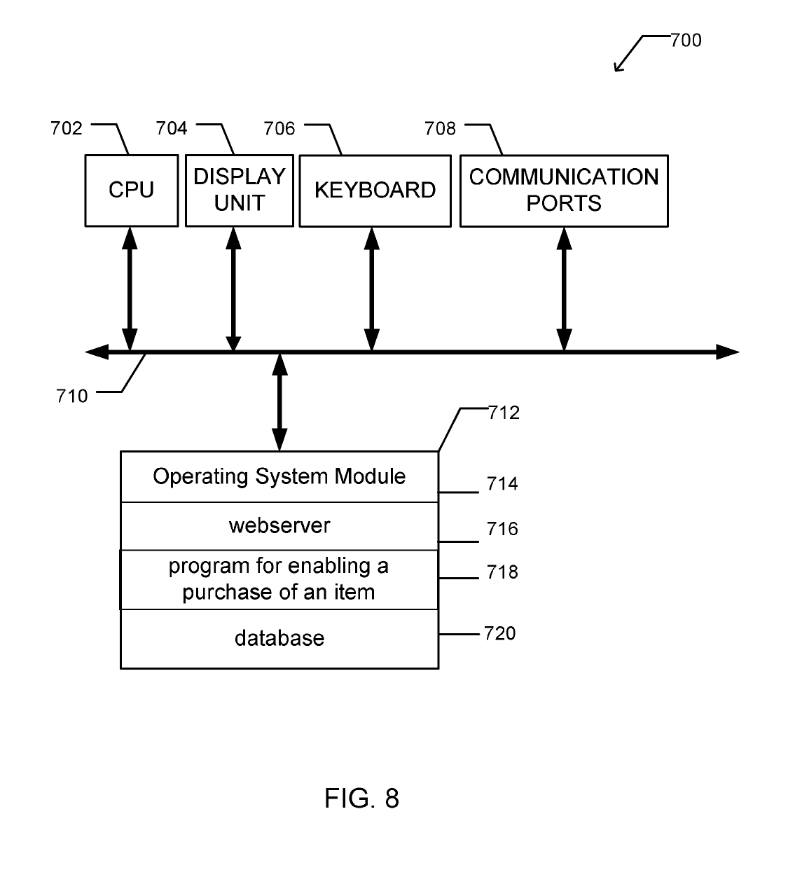

Now referring to FIG. 8, there is shown an embodiment of a processing device 700 which may be used for implementing the apparatus for enabling a customer to perform a transaction 104.

The computer 700, also referred to as a processing device, comprises a Central Processing Unit (CPU) 702, a display unit 704, a keyboard 706, communication ports 708, a data bus 710 and a memory 712.

The Central Processing Unit 702, the display unit 704, the keyboard 706 and the memory 712 are connected together using the data bus 710.

In a preferred embodiment, the computer 700 is a server comprising a central processing unit 702 which is a 2× Intel™ Xeon Quad Core E 5606 running at 2.13 GHz.

Still in this embodiment, the display unit 704 is a standard display.

The communication ports 708 are used for enabling the computer 700 to share data with other processing devices. Examples of other processing devices comprise a processing device of a customer, a processing device of a client, etc.

The memory 712 is used for storing data.

In this embodiment, the memory 712 comprises a SATAII hard drive having a size of 500 GB.

More precisely and still in this embodiment, the memory 712 comprises, inter alia, an operating system module 714.

The operating system module 714 is Windows™ 2008 64 bits manufactured by Microsoft™.

The memory 712 further comprises a web server 716. In a preferred embodiment, the web server 716 is a Microsoft™ SQL based system created in ColdFusion™.

The memory 712 further comprises a program for enabling a purchase of an item 718.

The memory further comprises a database 718 for storing data.

More precisely, the program for enabling a purchase of an item 718 comprises instructions for enabling the customer to select an item to buy on an interface.

The program for enabling a purchase of an item 718 comprises instructions for determining a price for the item to buy.

The program for enabling a purchase of an item 718 further comprises instructions for displaying on an interface an invitation to a customer for entering more than one point value, each of the more than one point value being associated with a loyalty program of the plurality of loyalty programs. The displaying of the invitation to a customer for entering more than one point value is performed using the web server 716 in one embodiment.

The program for enabling a purchase of an item 718 further comprises instructions for determining a total redeemed amount associated with the entered more than one point value upon entering of the more than one point value.

The program for enabling a purchase of an item 718 further comprises instructions for comparing the total redeemed amount to the determined price of the item to buy.

The program for enabling a purchase of an item 718 further comprises instructions for completing the transaction if the total redeemed amount is equal to the determined price.

The program for enabling a purchase of an item 718 further comprises instructions for offering the customer to pay a difference using a cash payment if the determined total redeemed amount associated with the entered more than one point value is lower than the determined price of the item to buy.

The program for enabling a purchase of an item 718 further comprises instructions for completing the transaction if the cash payment is made.

The program for enabling a purchase of an item 718 further comprises instructions for determining a profit made from the transaction and for providing a share of the profit determined to the client supplying the loyalty point program that the customer used in proportion to points used for payment.

It will be appreciated that the program for enabling a purchase of an item 718 may be received via the communication port 708.

It will be appreciated that a computer-readable storage medium may be provided for storing computer-executable instructions. Such computer-executable instructions, when executed, would cause a processing device to perform a method for enabling a customer to perform a transaction for an item, the customer being a member of a plurality of loyalty programs, the method comprising the customer selecting an item to buy on an interface, determining a price for the item to buy, displaying the interface an invitation to the customer for entering more than one point value, each of the more than one point value being associated with a loyalty program of the plurality of loyalty programs; upon entering of the more than one point value; determining a total redeemed amount associated with the entered more than one point value and comparing the total redeemed amount to the determined price of the item to buy and completing the transaction if the total redeemed amount is equal to the determined price; if the determined total redeemed amount associated with the entered more than one point value is lower than the determined price of the item to buy, offering the customer to pay a difference using a cash payment and completing the transaction if the cash payment is made; if the transaction is completed, determining a profit made from the transaction and providing a share of the profit determined to the client supplying the loyalty point program that the customer used in proportion to points used for payment.

Although the above description relates to a specific preferred embodiment as presently contemplated by the inventor, it will be understood that the invention in its broad aspect includes mechanical and functional equivalents of the elements described herein.

1. A method for enabling a customer to perform a transaction for an item, the customer being a member of a plurality of loyalty programs, the method comprising:
determining a price for an item to buy by the customer,
displaying on the interface an invitation to the customer for entering more than one point value, each of the more than one point value being associated with a loyalty program of the plurality of loyalty programs, each loyalty program being managed by a client;
upon entering of the more than one point value;
determining a total redeemed amount associated with the entered more than one point value and comparing the total redeemed amount to the determined price of the item to buy and
completing the transaction if the total redeemed amount is equal to the determined price;
if the determined total redeemed amount associated with the entered more than one point value is lower than the determined price of the item to buy, offering the customer to pay a difference using a cash payment and completing the transaction if the cash payment is made;
if the transaction is completed, determining a profit made from the transaction and providing a share of the profit determined to the client managing the loyalty point program that the customer used in proportion to points used for payment.

2. The method as claimed in claim 1, wherein the customer is one of an individual, a group of individuals, a corporation, a group of corporations.

3. The method as claimed in claim 1, wherein the determining of a price for an item to buy by the customer comprises displaying an interface to the customer, the user selecting the item to buy on the user interface and determining a price for the selected item to buy.

4. The method as claimed in claim 3, wherein the displaying of an interface to the customer comprises accessing a website and browsing the website.

5. The method as claimed in claim 3, wherein the displaying of an interface to the customer comprises executing an application.

6. The method as claimed in claim 1, wherein the determining of a price for the item to buy comprises accessing a database and obtaining the price from the accessed database.

7. The method as claimed in claim 6, further comprising obtaining another price from another third party price source and modifying the determined price if the obtained price from the other third party price source is lower than the determined source.

8. The method as claimed in claim 1, further comprising the customer registering before determining a price for an item to buy by the customer.

9. The method as claimed in claim 8, wherein the registering comprises providing an indication of the plurality of loyalty programs, the customer is member of.

10. The method as claimed in claim 9, wherein the registering further comprises providing login access information for each of the loyalty programs of the plurality.

11. The method as claimed in claim 1, wherein the determining of a total redeemed amount associated with the entered more than one point value comprises accessing a table comprising a redeemed value of a point for each of the entered more than one point value.

12. The method as claimed in claim 1, wherein the completing of the transaction if the total redeemed amount is equal to the determined price comprises for each of the entered more than one point value accessing a corresponding loyalty program site to ensure the customer has a sufficient amount of points available in his corresponding account.

13. The method as claimed in claim 12, wherein performing the cash payment comprises using one of using a credit card and an online payment system.

14. The method as claimed in claim 1, wherein the profit determined comprises a net profit.

15. The method as claimed in claim 1, further comprising providing a share of the profit made to the customer.

16. The method as claimed in claim 15, wherein the providing of the share of the profit made to the customer comprises at least one of providing the customer with a credit for a future transaction and crediting a credit card of the customer.

17. A computer-readable storage medium storing computer-executable instructions which, when executed, cause a processing device to perform a method for enabling a customer to perform a transaction for an item, the customer being a member of a plurality of loyalty programs, each loyalty program being managed by a client, the method comprising:
the customer selecting the item to buy on an interface,
determining a price for the item to buy,
displaying on the interface an invitation to the customer for entering more than one point value, each of the more than one point value being associated with a loyalty program of the plurality of loyalty programs;
upon entering of the more than one point value;
determining a total redeemed amount associated with the entered more than one point value and comparing the total redeemed amount to the determined price of the item to buy and
completing the transaction if the total redeemed amount is equal to the determined price;
if the determined total redeemed amount associated with the entered more than one point value is lower than the determined price of the item to buy, offering the customer to pay a difference using a cash payment and completing the transaction if the cash payment is made;
if the transaction is completed, determining a profit made from the transaction and providing a share of the profit determined to the client managing the loyalty program that the customer used in proportion to points used for payment.

18. A computing device, the computing device comprising:
a display device;
a central processing unit;
a memory comprising a program, wherein the program is stored in the memory and configured to be executed by the central processing unit, the program comprises:
instructions for enabling a customer to select an item to buy on an interface;
instructions for determining a price for the item to buy;
instructions for displaying on a customer interface an invitation to the customer for entering more than one point value, each of the more than one point value being associated with a loyalty program of a plurality of loyalty programs;
instructions for determining a total redeemed amount associated with the entered more than one point value upon entering of the more than one point value;
instructions for comparing the total redeemed amount to the determined price of the item to buy;
instructions for completing the transaction if the total redeemed amount is equal to the determined price;
instructions for offering the customer to pay a difference using a cash payment if the determined total redeemed amount associated with the entered more than one point value is lower than the determined price of the item to buy;
instructions for completing the transaction if the cash payment is made;
instructions for determining a profit made from the transaction and for providing a share of the profit determined to the client managing the loyalty point program that the customer used in proportion to points used for payment.

19. The computing device as claimed in claim 18, further comprising a communication port, further wherein the program is received via the communication port.
